(19) United States
(12) Patent Application Publication
(10) Pub. No.: US 2005/0205219 A1
(43) Pub. Date: Sep. 22, 2005

(54) Non pull cord operated blind structure

(75) Inventor: Ben Hsu, Changhua Hsien (TW)

Correspondence Address: TROXELL LAW OFFICE PLLC, SUITE 1404, 5205 LEESBURG PIKE, FALLS CHURCH, VA, 22041, US

(73) Assignee: Ching Feng Blinds Ind. Co., Ltd.

(21) Appl. No.: 10/805,265

(22) Filed: Mar. 22, 2004

(51) Int. Cl. E06B 9/30

(52) U.S. Cl. 160/170

(57) ABSTRACT

A non-pull cord operated blind structure includes a retaining box, a recoiling spring element, a movable member, a control button, and a cover wherein the retaining box is equipped with an engaging cavity having a locating rod protruding at the center thereof to be registered with the movable member thereby, and the recoiling spring element has an inserting hook piece and a fixing piece disposed at both ends thereon to be securely attached to a recess of the locating rod thereof and an engaging hook of the movable member respectively thereby. The movable member is provided with a retaining chamber having two opposite abutting blocks with tapered guide slopes protruding at the inner periphery thereon to be abutted against tapered locating plates of the control button so as to precisely locate the movable member with retaining cords collected therein. Thus, the recoiling spring element is activated to compress tight or rebound loose by the retaining cords which is either stretched out by a lower beam pulled downwards after the control button is pushed to detach the locating plates thereof off from the abutting blocks thereof in the unfolding operation of a blind, or released from the gravity pull of the lower beam raised upwards in the folding operation thereof, facilitating an easy and fast adjustment of the non-pull cord operated blind structure.

### BACKGROUND OF THE INVENTION

The present invention is related to a non-pull cord operated blind structure, including a retaining box, a recoiling spring element, a movable member, a control button, and a cover wherein the retaining box is equipped with an engaging cavity having a locating rod protruding at the center thereof to be registered with the movable member thereby, and the recoiling spring element has a fixing piece and an inserting hook piece disposed at both ends thereon to be attached to the locating rod and the movable member respectively thereby. The movable member is provided with a retaining chamber having two opposite abutting blocks with tapered guide slopes protruding at the inner periphery thereon to be abutted against tapered locating plates of the control button so as to precisely locate the movable member with retaining cords collected therein; whereby, the recoiling spring element is activated to compress tight or rebound loose by the retaining cords which is ether stretched out by a lower beam pulled downwards after the control button is pushed, or released by the lower beam raised upwards in the unfolding or folding operation thereof, facilitating an easy and fast adjustment of the non-pull cord operated blind structure.

A conventional Venetian blind is usually made up of a turbo-wheel unit in cooperation with pull cords and T-shaped cords, which is quite tediously complex in assembly. Besides, when the Venetian blind is gathered up, pull cords are suspended downwards for a certain length outside the blind thereof. Children playing around the blind may easily get caught by the suspending pull cords. In case the blind is careless unfolded, the withdrawing pull cords might hurt or even strangle the children got caught in them. Thus, the conventional Venetian blind poses a potential danger to children in the family.

### SUMMARY OF THE PRESENT INVENTION

It is, therefore, the primary purpose of the present invention to provide a non-pull cord operated blind structure, including a retaining box, a recoiling spring element, a movable member, a control button, and a cover wherein the retaining box is equipped with an engaging cavity having a locating rod protruding at the center thereof to be registered with the movable member thereby, and the recoiling spring element has an inserting hook piece and a fixing piece disposed at both ends thereon to be securely attached to an engaging hook of the movable member and a recess of the locating rod thereof respectively; whereby, the recoiling spring element is activated to compress tight or rebound loose by retaining cords that are either stretched out by a lower beam pulled downwards after the control button is pushed, or released when the lower beam is raised in the unfolding or folding operation, facilitating an easy and fast adjustment of the non-pull cord operated blind structure.

It is, therefore, the second purpose of the present invention to provide a non-pull cord operated blind structure wherein the movable member is provided with a retaining chamber having two opposite abutting blocks with tapered guide slopes protruding at the inner periphery thereon to be abutted against tapered locating plates of the control button, precisely locating the movable member in a stable manner so as to prevent the blind thereof from sliding instantly downwards when affected by forces like gravitation and wind, or by impact from outside and to achieve the best using condition thereof.

It is, therefore, the third purpose of the present invention to provide a non-pull cord operated blind structure wherein via the recoiling spring element, the movable element, and the control button adapted at the retaining box therein, the retaining cords are securely gathered up or released in the folding or unfolding operation of the blind thereof, providing a non-pull cord operated blind structure so as to prevent children from getting hurt or strangled by pull cords accidentally and to ensure the safety of the family.

### BRIEF DESCRIPTION OF THE DRAWINGS

FIG. 1 is a perspective exploded view of the present invention.

FIG. 2 is a front sectional view of the present invention in assembly.

FIG. 3 is a cross sectional view of the present invention in assembly.

FIG. 4 is a partially enlarged and cross sectional view of the present invention.

FIG. 5 is a diagram showing the present invention mounted onto a lower beam.

FIG. 6 is another diagram showing the present invention mounted onto the lower beam thereof in another way.

FIG. 7 is a diagram showing the present invention in unfolding operation thereof.

FIG. 8 is a cross sectional view of another embodiment of the present invention in assembly.

FIG. 9 is a front sectional view of another embodiment of the present invention in assembly.

### DETAILED DESCRIPTION OF THE PREFERRED EMBODIMENTS

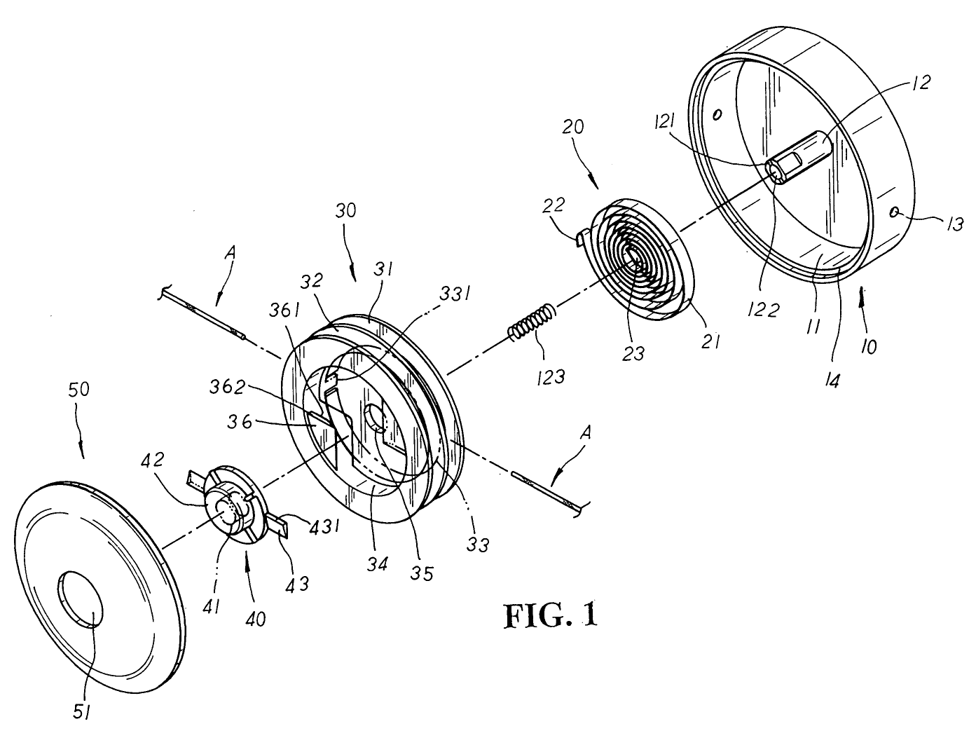

Please refer to FIG. 1. The present invention is related to a non-pull cord operated blind structure, including a retaining box 10, a recoiling spring element 20, a movable member 30, a control button 40, and a cover 50. The retaining box 10 is equipped with an engaging cavity 11 concaved at one side thereon, a locating rod 12 having level facets defined at both lateral sides thereon protruding at the center of the locating rod 12 thereof, a recess 121 of proper depth cut at the end of the locating rod 12 thereon, and a grooved hole 122 defining the center of the locating rod 12 thereof for a spring 123 to be adapted therein. Two cord passage holes 13 are disposed at both lateral walls of the retaining box 10 for a retaining cord A to be led there-through respectively, and a step-wise engaging seat 14 is disposed at the opening edge of the engaging cavity 11 thereon. The recoiling spring element 20 is made up of an elastic plate 21 wound into a spring coil with rebound elasticity and an inserting hook piece 22 and a fixing piece 23 disposed at both ends thereon respectively. The movable member 30 is equipped with a pair of first and second recoiling grooves 31, 32 symmetrically defining the outer periphery thereon, a limiting groove 33 disposed one lateral side thereof adjacent to a retaining chamber 34 separately disposed at the other lateral side thereof, and a central through hole 35 communicating both the limiting groove 33 and the retaining chamber 34 thereof. The limiting groove 33 has an engaging hook 331 defined by two clearances cut at one lateral side thereon, and the retaining chamber 34 is provided with two opposite abutting blocks 36 symmetrically protruding at the inner periphery of the opening edge thereon. The abutting block 36 thereof is made up of a tapered guide slope 361 defining the inner side thereon, and an abutting facet 362 disposed at one lateral side thereon. The control button 40 is equipped with a sleeve groove 41 concaved at one side therein in match with the locating rod 12 of the retaining box 10 thereof, a step-wise press section 42 protruding at the other side thereof, and a pair of opposite and tapered locating guide plates 43 symmetrically extending at the outer periphery thereon each having a locating facet 431 defining one lateral side thereon. The cover 50 is provided with a button through hole 50 disposed at the center thereon.

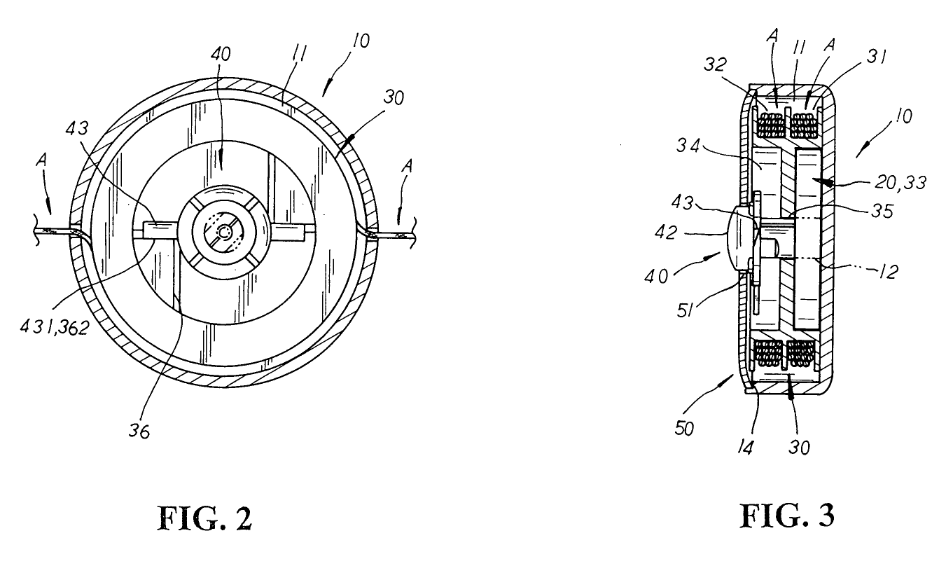

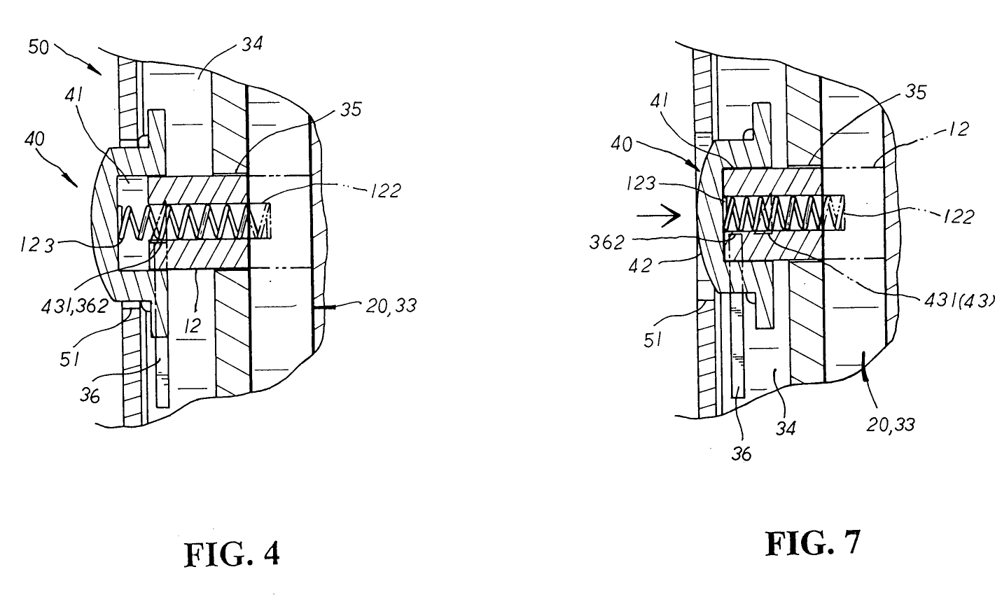

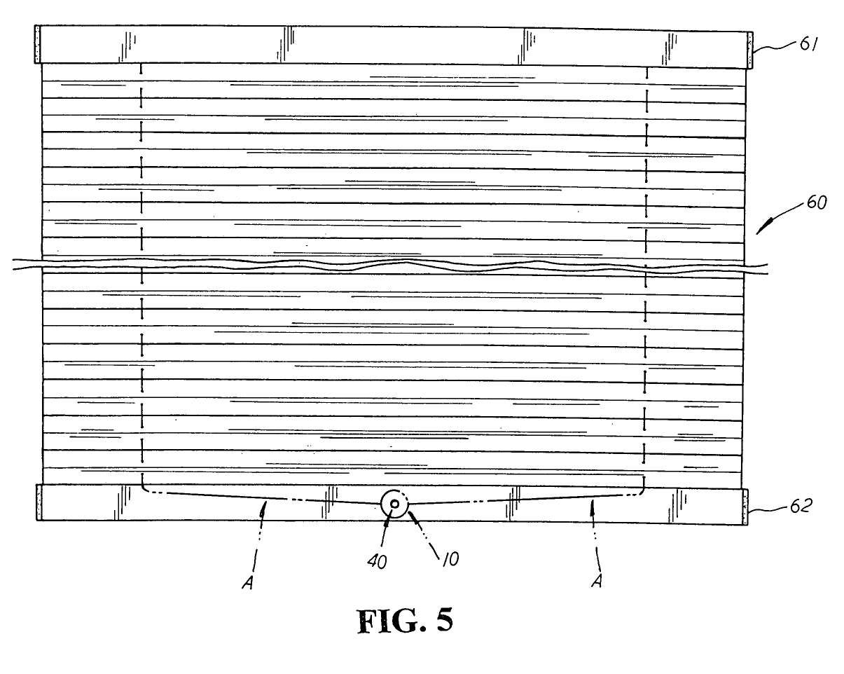

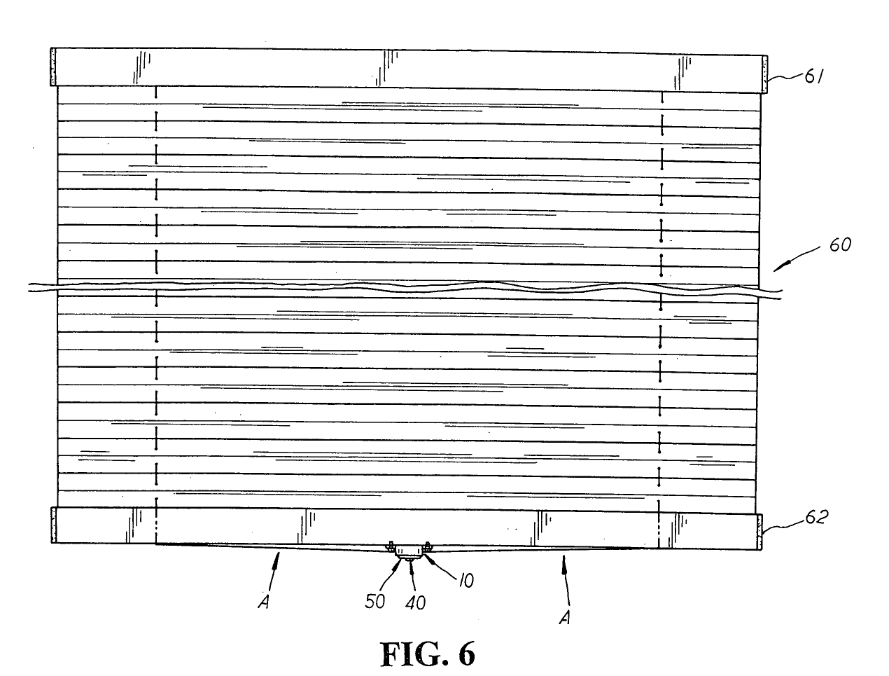

Please refer to FIGS. 2 to 6 inclusive. In assembly, two retaining cords A are respectively wound and collected at the first/second recoiling grooves 31, 32 of the movable member 30, and the inserting hook piece 22 of the recoiling spring element 20 is fixedly attached to the engaging hook 331 of the movable member 30 thereof to locate the recoiling spring element 20 at the limiting groove 33 therein. The fixing piece 23 of the recoiling spring element 20 is then inserted to the recess 121 of the locating rod 12 to engage the central through hole 35 of the movable member 30 with the locating rod 12 thereof till the locating rod extended at the retaining chamber 34 therein and the opening edge of the limiting groove 32 abutted against the engaging cavity 11 of the retaining box 10 thereof. Thus, the recoiling spring element 20 wound at the outer periphery of the locating rod 12 thereof is securely retained at the limiting groove 33 therein, and the movable member 30 is completely received at the engaging cavity 11 of the retaining box 10 thereof. The retaining cords A collected at the first/second recoiling grooves 31, 32 therein are respectively led through the cord passages holes 13 thereof to come out of the retaining box 10 at the other end thereof, and the spring 123 is adapted into the grooved hole 122 of the locating rod 12 before the sleeve groove 41 of the control button 40 is joined to the locating rod 12 in sleeve engagement therewith. The cover 50 is located onto the step-wise engaging seat 14 of the retaining box 10 and registered therewith till the step-wise press section 42 of the control button 40 extending out at the button passage hole 51. Meanwhile, the control button 40 is elastically abutted by the spring 123 thereof with the locating facets 431 of the locating guide plates 43 thereof correspondingly stopped by the abutting facets 362 of the abutting blocks 36 thereof respectively in abutting location thereby as shown in FIG. 4. Finally, the two retaining cords A are led through both lateral sides of a blind 60 before attached to an upper beam 61 wherein the assembly of the present invention can be securely mounted at the inner lateral side of a lower beam 62 as shown in FIG. 5, or at the outer bottom side thereof as shown in FIG. 6.

Please refer to FIG. 7. In practical use, the press section 42 of the control button 40 is pushed inwards at the retaining chamber 34 of the movable member 30 therein to compress the spring 123 and detach the locating facets 431 of the guide plates 43 off from the abutting facets 362 of the abutting blocks 36 therewith. The lower beam 62 is then pulled downward to stretch out the retaining cords A that, in turn, will activate the rotation of the movable member 30 therewith. With the inserting hook piece 22 and the fixing piece 23 securely attached at the engaging hook 331 of the movable member 30 and the recess 121 of the locating rod 12 respectively, the elastic plate 21 of the recoiling spring element 20 will rotate with the movable member 30 and wind along the locating rod 12 till compressed into a tight spring coil. When the lower beam 62 is adjusted into a proper position and the push movement applied onto the control button 40 is removed, the spring 123 will elastically bounce back to relocate the control button 40 with the locating facets 431 of the guide plates 43 thereof correspondingly realigned and stopped by the abutting facets 362 of the abutting blocks 36 in abutting location thereby. Thus, the movable member 30 is precisely relocated in the unfolding operation of the blind 60. And via the recoiling spring element 20 compressed tight into a spring coil, the blind 60 is easily gathered upwards in the folding operation thereof. The lower beam 62 is pushed upwards to release the retaining cords A from the gravity stretch of the lower beam 62 in a loose manner and loosen the movable member 30 as well. The compressed recoiling spring element 20 will then rebound loose to one side, which will simultaneously actuate the rotation of the movable member 30 therewith. Via the tapered design thereof, the guide slopes 361 of the movable member 30 are smoothly slid along the locating guide plates 43 of the control button 40 and rotated quickly to one side therewith. Thus, the released retaining cords A are retrieved and collected at the first/second recoiling grooves 31, 32 therein respectively with the rolling of the movable member 30 thereof. When the blind 60 is gathered at a required position, the lower beam 62 raised upwards is suspended downwards to stretch the retaining cords A which, affected by the gravity force of the lower beam 62 again, will pull the movable member 30 towards the other side therewith. Thus, the locating facets 431 of the control button 40 will abut against the abutting facets 362 of the movable member 30, precisely relocating the blind 60 thereof at a required position in the folding operation thereof.

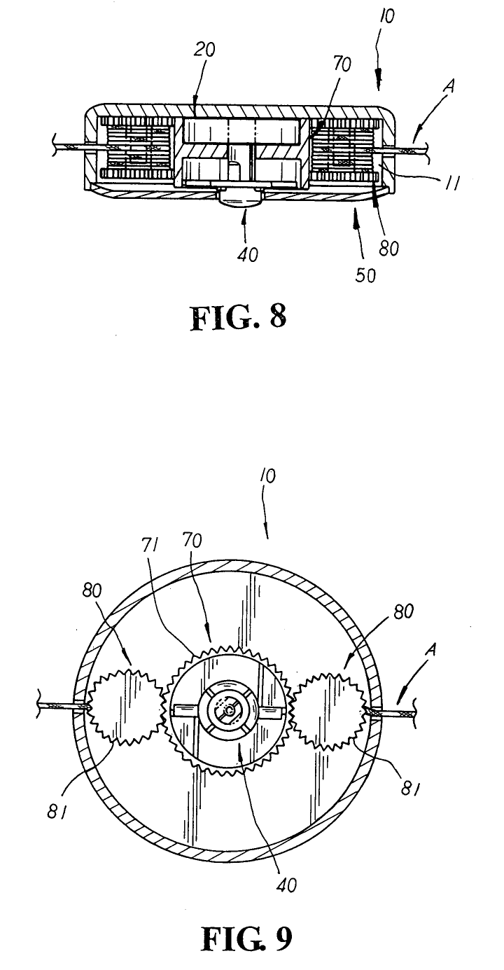

Please refer to FIGS. 8 to 9 inclusive. The present invention can also have a movable member 70 with a plurality of toothed edges 71 defining the outer periphery thereon, and two recoiling gears 80 having external toothed facets 81 disposed thereon in mesh with the toothed edges 71 of the movable member 70 thereby. The two recoiling gears 80 are adapted at both lateral sides of the movable members 70 and activated by the two retaining cords A wound and gathered therein respectively. When the press section 42 of the control button 40 is pushed, the lower beam 62 is drawn downwards to stretch out the two retaining cords A that, in turn, will actuate the rolling of the recoiling gears 80 therewith. The external toothed facets 81 of the recoiling gears 80 will sequentially mesh with the toothed edges 71 thereof to rotate the movable member 70 therewith. The recoiling spring element 20 will then move along the locating rod 12 thereof and compress into a tight spring coil in the unfolding operation of the blind 60 thereof. To gather upwards the blind 60, the lower beam 62 is pushed upwards to release the retaining cords A from the gravity pull of the lower beam 62 and simultaneously loosen the recoiling gears 80 therewith. The compressed recoiling spring element 20 will rebound loose to one side and actuate the rotation of the movable member 70 therewith. Thus, with the toothed edges 71 in mesh with the external toothed facets 81 thereof, the movable member 70 will rotate the recoiling gears 80 to wind up and collect the released retaining cords A at the recoiling gears 80 therein in the folding operation of the blind 60 thereof.

1. A non-pull cord operated blind structure, including a retaining box, a recoiling spring element, a movable member, a control button, and a cover wherein the retaining box is equipped with an engaging cavity concaved at one side thereof, a locating rod protruding at the center of the locating rod thereof, a recess of proper depth cut at the end of the locating rod thereon, grooved a hole defining the center of the locating rod thereof for a spring to be adapted therein, and two cord passage holes disposed at both lateral walls thereof for a retaining cord to be led there-through respectively; the recoiling spring element is provided with rebound elasticity, and the movable member is equipped with a pair of first and second recoiling grooves separately disposed at the outer periphery thereon, a limiting groove defining one lateral side thereof adjacent to a retaining chamber individually disposed at the other lateral side thereof, and a central through hole communicating both the limiting groove and the retaining chamber thereof; the limiting groove of the movable member has an engaging hook defined by two clearances cut at one lateral side thereon, and the retaining chamber thereof is provided with two opposite abutting blocks symmetrically protruding at the inner periphery of the opening edge thereon; the abutting block thereof has a tapered guide slope defining the inner lateral side thereon and an abutting facet disposed at one lateral end thereon; the control button is provided with a sleeve groove concaved at one side therein in match with the locating rod of the retaining box thereof, a step-wise press section protruding at the other side thereof, and a pair of opposite and tapered locating guide plates symmetrically extending at the outer periphery thereon, each having a locating facet defining one lateral end thereon; the cover is provided with a button through hole disposed at the center thereon.

2. The non-pull cord operated blind structure as claimed in claim 1 wherein the locating rod of the retaining box thereof has level facets cut at both lateral side of one end thereon.

3. The non-pull cord operated blind structure as claimed in claim 1 wherein the engaging cavity of the retaining box thereof has a step-wise engaging seat disposed at the opening edge thereon.

4. The non-pull cord operated blind structure as claimed in claim 1 wherein the recoiling spring element thereof is made up of an elastic plate wound up into an elastic spring coil.

5. The non-pull cord operated blind structure as claimed in claim 1 wherein both ends of the recoiling spring element thereof are folded up into an inserting hook piece and a fixing piece to be fixedly attached to the engaging hook of the movable member and the recess of the locating rod of the retaining box respectively thereby.

6. The non-pull cord operated blind structure as claimed in claim 1 wherein the present invention can also have a movable member equipped with a plurality of toothed edges defining the outer periphery thereon, and two recoiling gears having external toothed facets 81 disposed thereon in mesh with the toothed edges of the movable member thereby; the two recoiling gears, adapted at both lateral sides of the movable members for the two retaining cords to be wound and gathered thereto, are activated by the two retaining cords stretched or released by the lower beam in the folding or unfolding operation of the blind thereof.
